(19) United States
(12) Patent Application Publication
(10) Pub. No.: US 2007/0118473 A1
(43) Pub. Date: May 24, 2007

(54) Close proximity transactional mobile system

(76) Inventor: Eduardo Chapeta, Cordoba (AR)

Correspondence Address: Steven L. Schmid, 44 Coral Street, Atlantic Beach, FL, 32233, US

(21) Appl. No.: 11/405,273

(22) Filed: Apr. 17, 2006

Related U.S. Application Data
(63) Continuation-in-part of application No. 11/256,635, filed on Oct. 21, 2005.

(51) Int. Cl. G06Q 40/00

(52) U.S. Cl. 705/40

(57) ABSTRACT

Disclosed is a transactional mobile system having a central hub in communication with a wireless network wherein a wireless device is in communication with a collection point. The communication between the wireless device and collection point is that of line of sight communication whereby the communication between the two occurs at a distance where visual contact between them can be made. Typically, the system may be used for transactions requiring speed and for relatively small amounts. However the present system is not limited by the amount of the transaction.

### CROSS-REFERENCE TO RELATED APPLICATION

This application is a continuation-in-part of U.S. patent application Ser. No. 11/256,635, filed Nov. 21, 2005, the contents of which are hereby incorporated in their entirety.

### TECHNICAL FIELD

The present system relates to a method of purchasing goods and services and in greater detail the present system relates to a method of transferring money for payment of goods and services, both real and virtual, which are facilitated by the use a mobile device or wireless network in close proximity with a collections point.

### BACKGROUND

Sales transactions in today's economy can be done by a number of mechanisms, including in person with direct contact with a merchant selling goods and/or services (called herein a Point of Sales (POS) transaction), by using a telephone, by using the Internet, by using the mail, and even by using an interactive cable television system. In the context of this application, the term merchant includes any party selling or offering for sale an item of goods or services, and can include a business person or another individual. The sales are consummated by a payment mechanism that is either a payment by cash, check, credit card, debit card or pre-paid cards. If payment is done by check, credit card or debit card, then a payment system must be used which usually involves a clearance center (CC).

Most existing payment systems use a bank or other financial organization as the clearance center. Many sales establishments, which can include retail stores, telephone marketers, Internet web sites, or mail catalog centers, have business relationships with the clearance centers whereby the sales establishments can accept payments for the merchandise or services by a check, credit or debit card. In some personal point of service locations there are direct communication links with the clearance center. Usually these links are by dedicated telephone lines which connect, for example, an establishment's Point Of Sale or POS device that is a dedicated piece of hardware equipment and can include a sales establishment's keypad, a customer's keypad, or a card reader which can be combined with one of the foregoing or can be a separate piece of equipment.

Security is always of paramount importance in any point of sales transactions. Usually the security is in the form of a password, or Personal Identification Number (PIN), that only the customer or user of the payment mechanism knows. Naturally, the use of such passwords has numerous problems that include the user forgetting the password, the hardware equipment being faulty, or a compromise in the password. In the conventional systems in use today, there is also no mechanism or system to validate that the user of the password is who he or she says. The user simply enters the password and if correct, the transaction proceeds.

Presently, payment via credit card typically is limited to fixed locations, such as department stores, restaurants, etc. This limitation presents a problem for the merchant who is highly mobile, such as a taxi driver or a merchant who does business in an outdoor market, for example. Mobile solutions have not been cost effective since they involve, spectrum utilization, which can be very costly. Additionally, present mobile solutions depend on the deployment of a wireless network for operations, adding further cost to the mobile solution.

Accordingly, it would be advantageous to provide a payment system that allows for a mobile merchant as well as a fixed location merchant to accept payment via credit card, debit card or pre-paid cards. Therefore, there is a need in the art for a payment system that provides a secure environment for the transmission of financial information that is highly mobile and quick that can be operated in a line of sight between the devices. Additionally, it would be advantageous to provide a payment system that has minimal startup costs for the end user.

### SUMMARY

The present system includes a transactional mobile system having a central hub in communication with a wireless network wherein a wireless device is in communication with a collection point. The communication between the wireless device and collection point is preferably that of a line of sight communication. Typically, the present system may be used for transactions requiring speed and for relatively small amounts, for example payments less than five US dollars. However the present system is not limited by the amount of the transaction.

In greater detail, the transactional mobile system includes a wireless device signaling a transaction request to a collection point. The wireless device physically targets the collection point such that the two are in a position of visual contact. The system further includes a central hub in communication with the collection point wherein the central hub processes a transactional request approval from the collection point. The collection point may then render the requested transaction by the customer such as opening a toll gate or paying a fare.

In an additional embodiment, the transactional mobile system comprises a collection point signaling a wireless device containing transactional information. The collection point physically targets the wireless device with a signal such that the collection point and wireless device are in visual contact with each other. The wireless device then signals the collection point an approval of the transactional request. The system further includes a central hub in communication with the collection point wherein the central hub processes a transactional request for validating the request from the collection point. The central hub then further processes the validated request for payment and then signals the collection point upon approval of the payment.

A further embodiment includes the transactional mobile system comprising a mobile phone in communication with a collection device. The communication occurs in visual contact between the mobile phone and collection device. The mobile phone signals a transactional request to a collection point. The central hub communicates with the collection point wherein the central hub processes a transactional request for validating the request from the collection point. The central hub further processes the validated request for payment and signals the collection point upon approval of the payment. The system further includes the collection point signaling the mobile phone transactional information, wherein the transaction information includes an invitation to purchase. The system additionally includes the collection point rendering the requested transaction.

### DRAWINGS

In the drawings:

FIG. 1 is an overview flow diagram of the present method and system;

FIG. 2 is a block flow diagram illustrating the one phase embodiment of the present system; and

FIG. 3 is a block flow diagram illustrating the two phase embodiment of the present system.

### DETAILED DESCRIPTION

The present system includes a transactional mobile system having a central hub wherein the transaction occurs between a wireless device and a collection point in a visual contact or line of sight. The terms “visual contact” and “line of sight” are used herein to mean a communication that occurs at a distance such that an observer may see both the wireless device and the collection point. Such an observation is not required to be in the same field of vision and such a view may be somewhat obstructed.

The term “central hub” is used herein to mean any program or computer performing the functions described within the present specification. For example, the central hub may be embodied in one or more computers or servers wherein the central hub is in communication a wireless network(s) and/or various wireless devices. The central hub may use any type of signaling device and/or interface for communicating. The system is designed to provide secure electronic transactions in an easy to use system for both merchants and consumers.

Typically, the wireless device is a mobile phone but other such devices are contemplated such as PDAs, smart phones, notebooks or other devices that can access a mobile phone network, wireless network and/or WiFi network. A wireless network may include the Internet. The wireless device may be fitted with or modified to include various signal transmitters such as infrared, laser and the like for signaling a collection point.

The collection point may be any device and place where money is collected for services and/or goods. For example, but not by limitation, the collection point may be a toll plaza, subway, bus, taxi cab and/or a vending machine. Additionally, a collection point may be a retail establishment such a store, restaurant and/or vendor. The collection point includes a device for communicating with the central hub. Such a device may be wireless.

Security and verification can be accomplished by various means in the present system. Primarily, the user is identified and confirmed by a caller ID when the user contacts the central hub via a mobile phone through the collection point. Furthermore, the user may be identified by other means which carry the identity of the caller or user of a mobile device. Additional security measures may be taken such as prompting the user for a password or a PIN number. The user is further issued an identification by which the central hub further recognizes the user. Typically, this identification is in the form of a number. Collection points or businesses are given a business number and consumers or customers are given a customer number. A merchant would identify a customer by their number to the central hub and a customer would identify the business to the control hub by the business's number.

The central hub comprises a database wherein the information of each user is stored and cross referenced to determine verification when a user accesses the central hub. Users may be identified by caller ID or other mobile device user identification when a user accesses the central hub. A user may further be prompted for a password or PIN number if additional security is desired. Various means of interface with the central hub may be used. For example most any known method may be used such as pure SMS, IVR, Wap, Internet, email or Java using internally SMS or Internet access by use of wireless “mobile” data such as GPRS, EDGE and/or the like.

The central hub can further be connected to a transaction network to authorize payment or a transactional equivalent once verification has been accomplished. Such transaction networks may include by way of example Visa, MasterCard, Amex, ATM, bank accounts, service company bills, electronic money and/or a proprietary system. Example existing ATM/credit card infrastructures include standard computer data processing telecommunications networks for transmitting authorization requests is the VISA. RTM. credit transaction network. In addition to VISA. RTM. credit cards, merchants connected to this network may seek authorization for approval of transactions involving other credit cards, such as MASTER CARD. RTM. and DISCOVER. RTM. credit or debits cards. The VISA. RTM. credit transaction network includes a plurality of data processors and financial institutions, all interconnected through telecommunication links which, based on a six digit bank identification number (BIN), route all authorization requests to the appropriate card-issuer and all authorization responses back to the requesting authority.

Additionally, the central hub may act as a full transactional system without the need to contract an outside transactional network. The central hub may perform essentially the same function as the transactional network in that the central hub may have accounts created directly within the central hub. A user's credit line or balance in an account resides directly within the central hub and not with an outside transactional network. Thus, accounts residing within the central hub do not require the central hub to contact a transactional network for payment processing since such can be done by the central hub.

Furthermore, the central hub records and stores each transaction. Both externally and internally transactions are stored with the information being retrievable by an authorized user. The central hub further has a transparent mechanism which allows the users to consult and manages their various accounts, movements, audit logs and rights in a real time basis.

Once payment has been approved by the transaction network, the central hub my then signal the wireless device that the transaction has been accepted. The central hub may contact both parties confirming the approval along with providing a transaction identifier, such as a transaction number. Notification is typically sent to the user's mobile device but may be sent by other means.

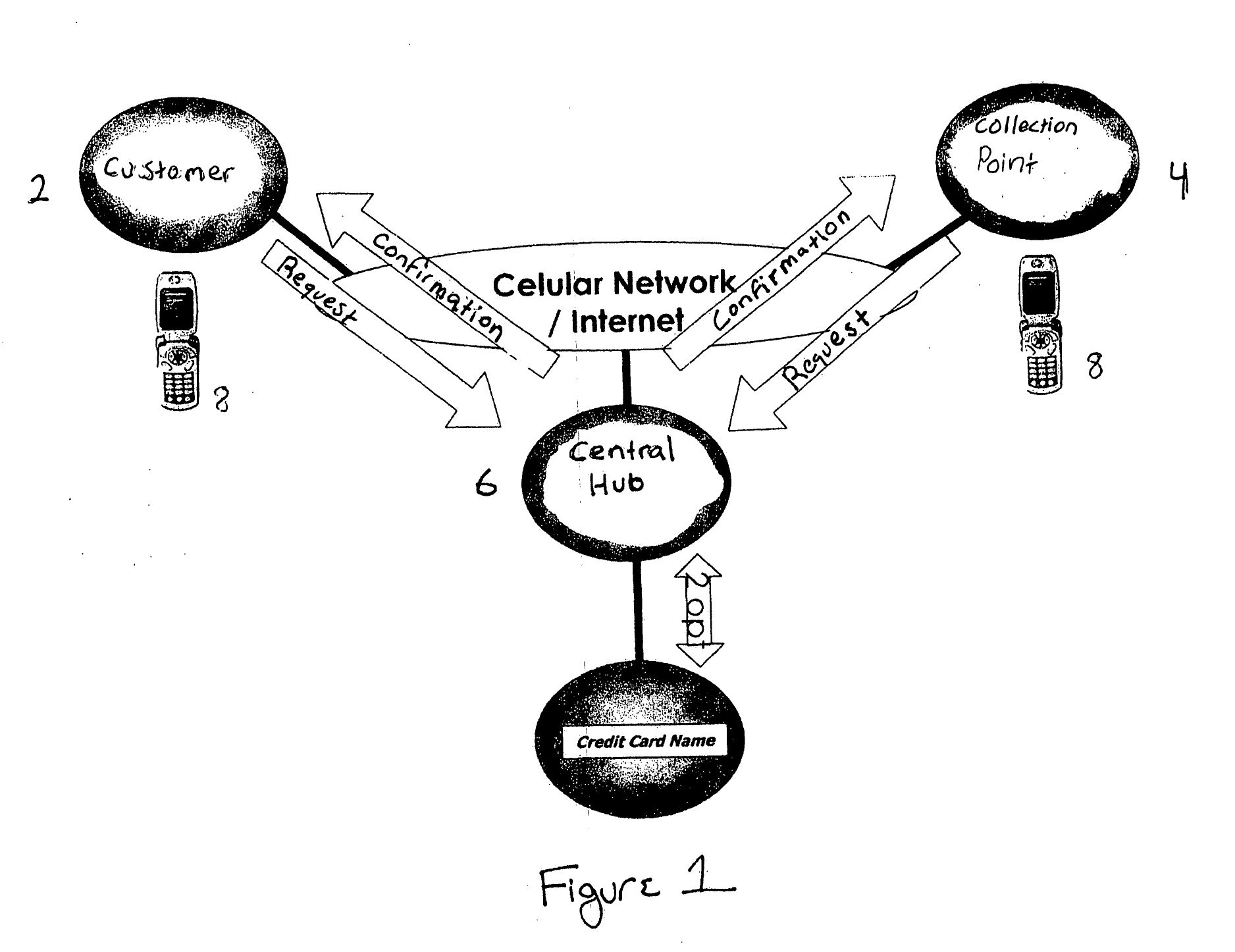

Turning now to the attached drawings, wherein like reference numerals will refer to like elements throughout, FIG. 1 represents an overall view of the present system. The customer 2 sends and receives signals from a mobile phone 8 to the collection point 4. The collection point 4 or merchant sends and receives signals to the central hub 6 from a wireless device 8 or other means. The query request or transactional request may include a caller ID and a transaction number and copy of the request to the other party. The transaction request may also include a price quotient. The central hub 6 verifies the users' caller IDs and contacts the transactional network for payment authorization.

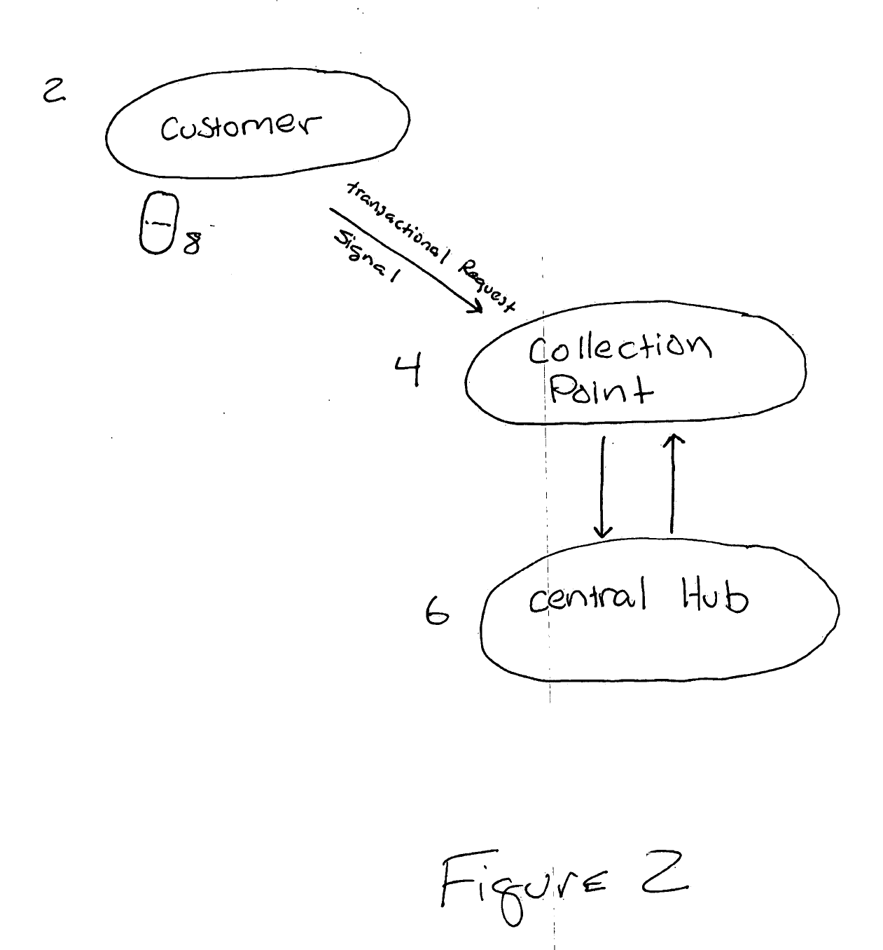

FIG. 2 illustrates the one phase embodiment of the present transactional mobile system. The one phase embodiment comprises the customer 2 approaching a collection point 4. For example, the collection point 4 may be a toll plaza. The customer 2 may then point a wireless device 8 in the direction of the collection point 4 while activating and sending a signal to the collection point 4. The signal may be initiated by a dedicated button on the wireless device 8. The collection point 4 may then communicate with the central hub 6 which approves the transaction. Once the transaction is approved, the collection point 4 may render the services or goods as so directed. For example, in the toll plaza embodiment a toll gate may be opened. In a vending machine embodiment, a soda can be dispensed. Furthermore, the central hub 6 may communicate with the wireless device 8 a receipt of the transaction.

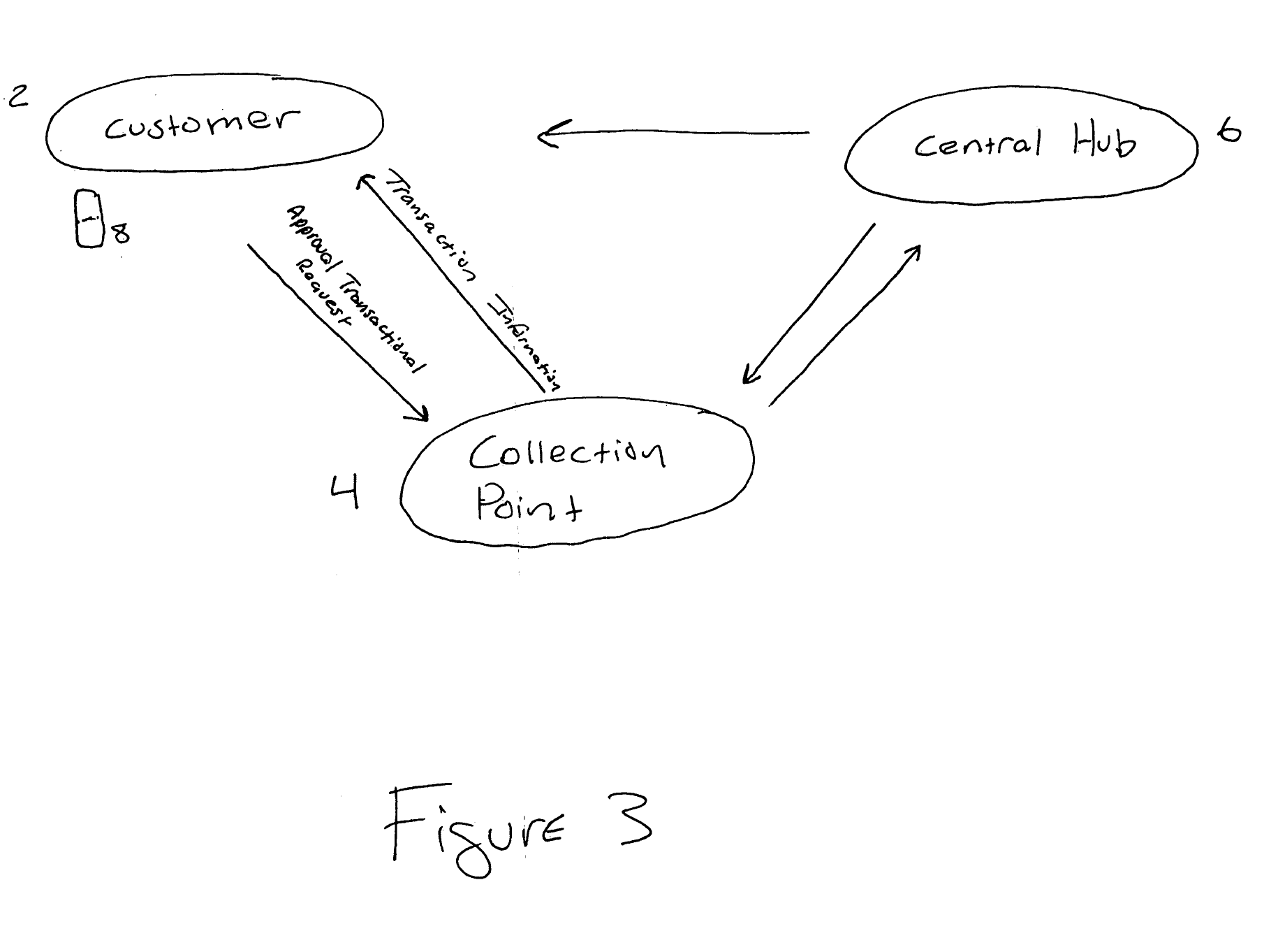

FIG. 3 depicts the two phase embodiment of the present transactional mobile system. The two phase embodiment comprises the customer 2 approaching a collection point 4. For example, the collection point 4 may be a store and cash register. The customer 2 may then point a wireless device 8 in the direction of the collection point 4 to receive transactional information from the collection point 4. The transactional information may contain such data as the price, quantity and description of the goods. The customer 2 may then send a signal through the wireless device 4 to the collection point 6 accepting or authorizing the transaction. The collection point 4 may then communicate with the central hub 6 which approves the transaction. Once the transaction is approved the collection point 4 may render the services or goods as so directed. Furthermore, the central hub 6 may communicate with the wireless device 8 and collection point 6 a receipt of the transaction. Additionally, the collection point 6 may signal the wireless device 8 a receipt for the transaction.

While applicants have set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. A transactional mobile system comprising:
a wireless device signaling a transactional request to a collection point, wherein the wireless device physically targets the collection point;
a central hub in communication with the collection point wherein the central hub processes a transactional request approval from the collection point; and
the collection point rendering the requested transaction.

2. The transactional mobile system of claim 1, wherein the collection point is selected from the group consisting of toll plazas, subways, buses, taxi cabs and combinations thereof.

3. The transactional mobile system of claim 1, the transactional request is a payment.

4. The transactional mobile system of claim 3, wherein the payment is for a fair or toll associated with a transportation authority.

5. The transactional mobile system of claim 1, wherein the wireless device is selected from the group consisting essentially of a mobile phone, PDA, notebook; a smart phone and combinations thereof.

6. The transactional mobile system of claim 1, further including the central hub signaling the wireless device upon the initiation and/or completion of a transaction.

7. The transactional mobile system of claim 1, wherein the wireless device remotely signals the collection device via a short range wireless technology.

8. The transaction mobile system of claim 7, wherein the wireless technology includes infrared signaling.

9. The transactional mobile system of claim 1, wherein the collection point includes a vending machine.

10. The transactional mobile system of claim 1, wherein the transactional request includes a customer identification.

11. The transactional mobile system of claim 1, wherein the central hub validates the request by cross referencing the transactional request with a known database.

12. A transactional mobile system comprising:
a collection point signaling a wireless device a transaction information, wherein the collection point physically targets the wireless device with the signal such that the collection point and wireless device are in visual contact with each other;
the wireless device signaling the collection point an approval transactional request;
a central hub in communication with the collection point wherein the central hub processes a transactional request for validating the request from the collection point;
the central hub further processing the validated request for payment; and
the central hub signaling the collection point upon approval of the payment.

13. The transactional mobile system of claim 12, wherein the step of the central hub processing the validated request for payment includes the central hub forwarding the validated request to a transactional network for payment.

14. The transaction mobile system of claim 12, wherein the wireless device is selected from the group consisting essentially of a mobile phone, PDA, notebook, smart phone and combinations thereof.

15. The transactional mobile system of claim 12, wherein the step of the central hub further processing the validated request for payment includes authorizing payment from an internal account held on the central hub.

16. The transactional mobile system of claim 11, wherein the wireless device remotely signals the collection device via a short range wireless technology.

17. The transaction mobile system of claim 16, wherein the wireless technology includes infrared signaling.

18. The transactional mobile system of claim 11, wherein the transactional request includes a customer identification.

19. The transactional mobile system of claim 11, wherein the central hub validates the request by cross referencing the transactional request with a known database.

20. A transactional mobile system comprising:
a mobile phone in communication with a collection point, wherein the communication occurring in visual contact between the mobile phone and collection point;
the mobile phone signaling a transactional request to a collection point;
a central hub in communication with the collection point wherein the central hub processes a transactional request for validating the request from the collection point;
the central hub further processing the validated request for payment; and
the central hub signaling the collection point upon approval of the payment.

21. The transactional mobile system of claim 20, further including the collection point signaling the mobile phone transactional information, wherein the transactional information includes an invitation to purchase.

22. The transactional mobile system of claim 21, wherein the transactional request includes an acceptance of the transactional information.

23. The transactional mobile system of claim 20, further including the collection point rendering the requested transaction.

24. The transactional mobile system of claim 20, further including the central hub validating the transactional request by comparing the data to that contained in a known database of user information.

25. The transactional mobile system of claim 20, further including the central hub forwarding the validated request to a transactional network for payment.

26. The transactional mobile system of claim 20, further including the central hub signaling the mobile phone upon approval of the payment by the transactional network.
